(19) United States
(12) Patent Application Publication
(10) Pub. No.: US 2025/0227481 A1
(43) Pub. Date: Jul. 10, 2025

(54) COORDINATED BANDWIDTH QUERY REPORT (CBQR) FORMAT

(71) Applicant: NEWRACOM, Inc., Irvine, CA (US)

(72) Inventors: Heejung YU, Daejeon (KR); Yeon-Geun LIM, Seoul (KR); Joonsoo LEE, Seoul (KR); Si-Chan NOH, Seoul (KR); Il-Gu LEE, Seoul (KR)

(73) Assignee: NEWRACOM, Inc., Irvine, CA (US)

(21) Appl. No.: 19/008,563

(22) Filed: Jan. 2, 2025

Related U.S. Application Data
(60) Provisional application No. 63/618,799, filed on Jan. 8, 2024.

(51) Int. Cl. H04W 16/10; H04L 5/00

(52) U.S. Cl. CPC H04W 16/10; H04L 5/0094

(57) ABSTRACT

An embodiment is a method performed by a station (STA) to provide a coordinated bandwidth query report (CBQR) to an access point (AP). The method includes generating a frame that includes an aggregated control (A-control) field, wherein the A-control field includes a CBQR field, wherein the CBQR field includes a basic service set (BSS) color field that carries a BSS color of a BSS and an available channel bitmap field that carries a bitmap indicating subchannel availability at the STA with respect to the BSS. The method further includes transmitting the frame to the AP.

### CROSS-REFERENCE TO RELATED APPLICATION

This application claims the benefit of U.S. Provisional Application No. 63/618,799, filed Jan. 8, 2024, titled “Coordinated Bandwidth Query Reports (CBQR) format and operation in beyond IEEE 802.11be”, which is hereby incorporated by reference.

### TECHNICAL FIELD

The present disclosure generally relates to wireless communications, and more specifically, relates to a coordinated bandwidth query report (CBQR) format.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

Existing wireless networking standards (e.g., IEEE 802.11be wireless networking standard or Extremely High Throughput (EHT)) allow a STA to provide a bandwidth query report (BQR) to an associated access point (AP). The BQR may include subchannel availability information such as information regarding which 20 Megahertz (MHz) subchannels within an operating channel bandwidth are available at the STA. The information provided by the BQR may be referred to as BQR information. A STA may provide a BQR to an associated AP by transmitting a frame to the associated AP that includes a BQR field (e.g., the BQR field may be included in an aggregated control (A-control) field of the frame). The BQR field may sometimes be referred to as a BQR control field. The BQR field may carry a bitmap indicating which 20 MHz subchannels within the operating channel bandwidth are available at the STA. The associated AP may determine which subchannels are available at the STA based on the bitmap carried by the BQR field. Multiple STAs associated with the AP may each provide a BQR to the AP to inform the AP of the subchannels available at the respective STAs. The AP's knowledge of which subchannels are available at different STAs may assist the AP in allocating downlink (DL) and/or uplink (UL) multi-user (MU) resources, which enables more efficient MU operations.

For future wireless networking standards (e.g., beyond IEEE 802.11be wireless networking standard or Ultra High Reliability (UHR)), multi-access point (multi-AP) coordination schemes are being considered as a way to enhance network performance. In a multi-AP coordination scenario, it may be useful for an AP to have information regarding which subchannels are available at a STA with respect to the basic service set (BSS) operated by the AP and also to have information regarding which subchannels are available at the STA with respect to any overlapping basic service set (OBSSs) operated by other APs. That is, it may be useful for the AP to have BQR information for its own BSS and any OBSSs. However, the current BQR format only allows a STA to provide BQR information for the STA's associated BSS to the AP.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing an example of BQR information gathered by various STAs in a wireless network in a multi-access point (M-AP) coordination scenario, according to some embodiments.

FIG. 11 is a diagram showing a format of a bandwidth query report (BQR) field in EHT.

FIG. 12 is a diagram showing a format of a coordinated bandwidth query report (CBQR) field, according to some embodiments.

FIG. 13 is a flow diagram of a method for providing a CBQR to an access point (AP), according to some embodiments.

### DETAILED DESCRIPTION

The present disclosure generally relates to wireless communications, and more specifically, relates to a coordinated bandwidth query report (CBQR) format.

As mentioned above, in a multi-access point (AP) coordination scenario, it may be useful for an AP to have bandwidth query report (BQR) information for its own basic service set (BSS) and one or more overlapping BSSs (OBSSs). However, the current BQR format only allows a station (STA) to provide BQR information for the STA's associated BSS to the AP.

Embodiments are described herein that allow a STA to provide BQR information for more than one BSS to an AP. According to some embodiments, a STA may transmit a CBQR to an AP to provide BQR information for more than one BSS. The STA may provide the CBQR to the AP by transmitting multiple CBQR fields to the AP (e.g., in an aggregated control (A-control) field of a frame). A CBQR field may also be referred to as a CBQR control field. Each CBQR field may include a BSS color field to carry a BSS color of a particular BSS and an available channel bitmap field to carry a bitmap indicating subchannel availability at the STA with respect to the particular BSS. The particular BSS may be the STA's associated BSS (i.e., the BSS to which the STA belongs (which may also be referred to herein as an associated BSS with respect to the STA) or a different BSS (which may be referred to herein as an OBSS with respect to the STA). The AP may use the BQR information carried in the multiple CBQR fields to determine which subchannels are available at the STA with respect to the different BSSs. The AP may use such knowledge to determine the appropriate coordination scheme, operating bandwidth, and/or subchannel allocation to use for multi-AP coordination operations. Unlike a conventional BQR that only allows a STA to provide BQR information for the STA's associated BSS to the AP, a CBQR may allow a STA to provide BQR information for the STA's associated BSS and/or one or more OBSSs with respect to the STA to the AP.

An embodiment is a method performed by a STA to provide a CBQR to an AP. The method includes generating a frame that includes an A-control field, wherein the A-control field includes a CBQR field, wherein the CBQR field includes a BSS color field that carries a BSS color of a BSS and an available channel bitmap field that carries a bitmap indicating subchannel availability at the STA with respect to the BSS. The method further includes transmitting the frame to the AP. The A-control field may further include a second CBQR field, wherein the second CBQR field includes a second BSS color field that carries a second BSS color of a second BSS and a second available channel bitmap field that carries a second bitmap indicating subchannel availability at the STA with respect to the second BSS. In an embodiment, the BSS is the STA's associated BSS and the second BSS is an OBSS with respect to the STA. In this way, the STA is able to provide BQR information for both the BSS and the OBSS to the AP.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

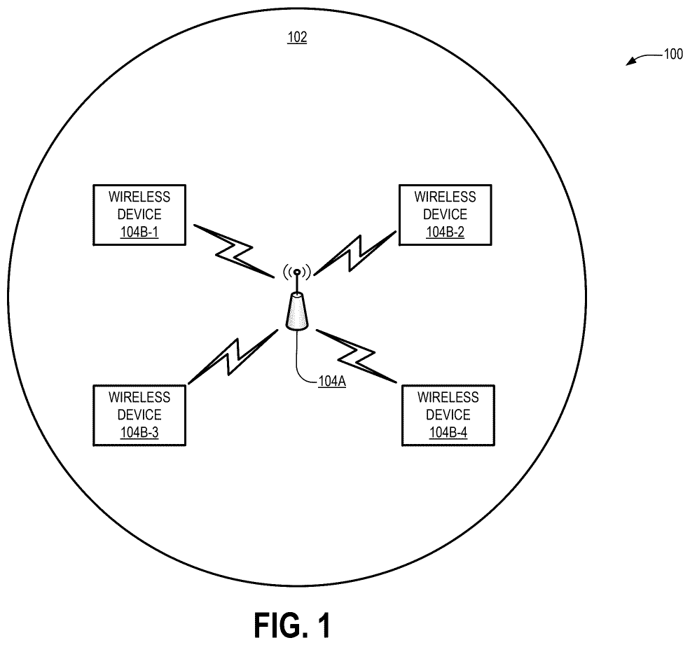

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

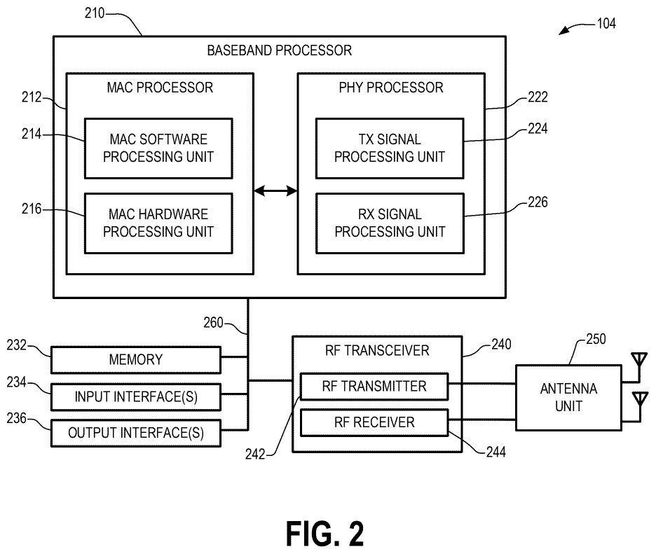

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-

Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

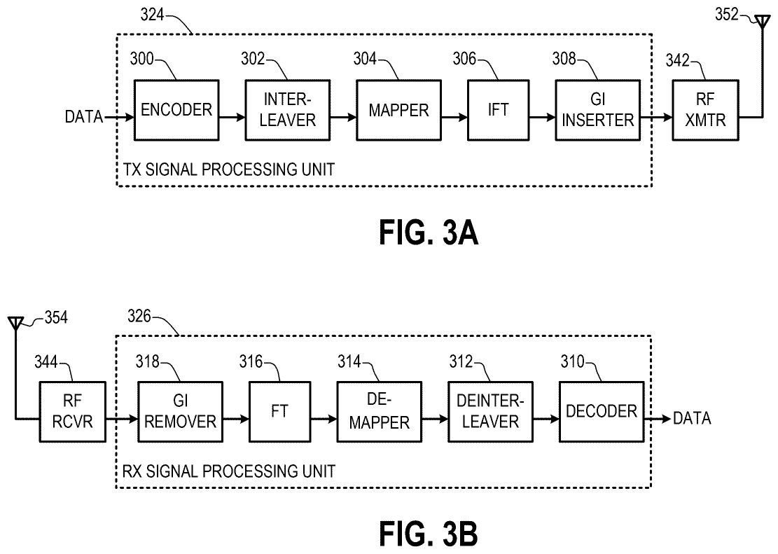

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0 s or 1 s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

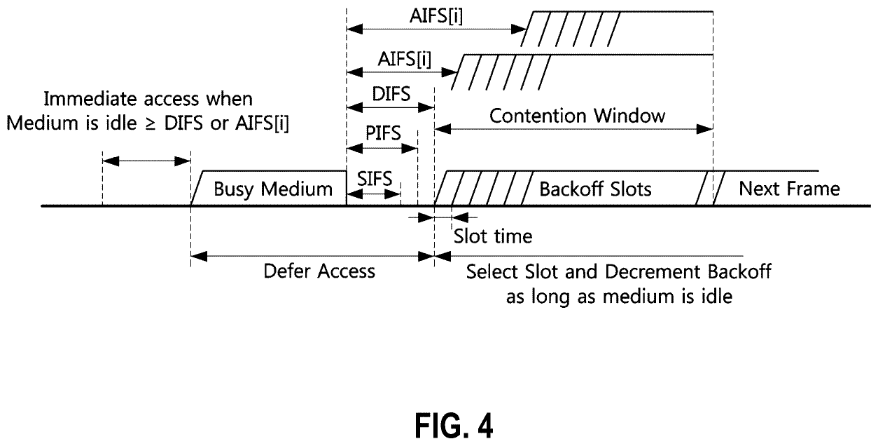

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

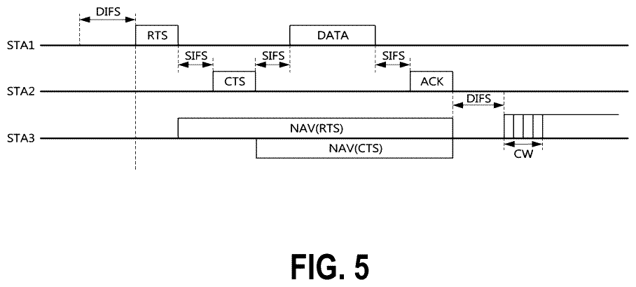

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

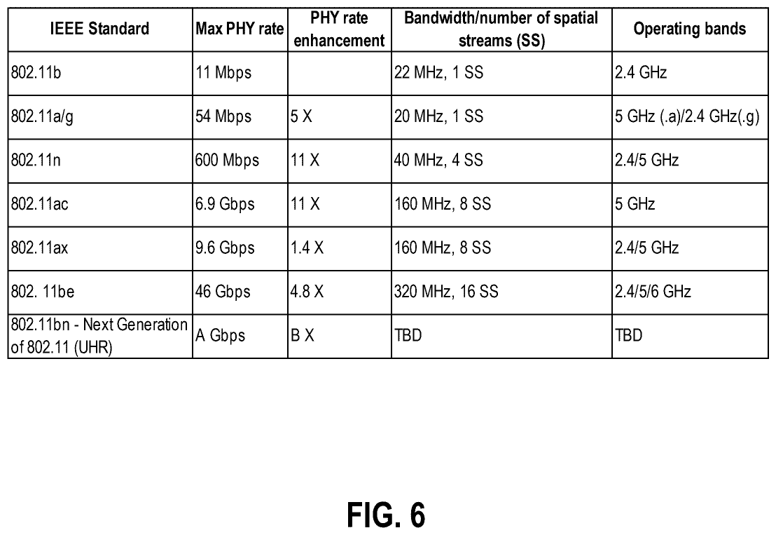

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

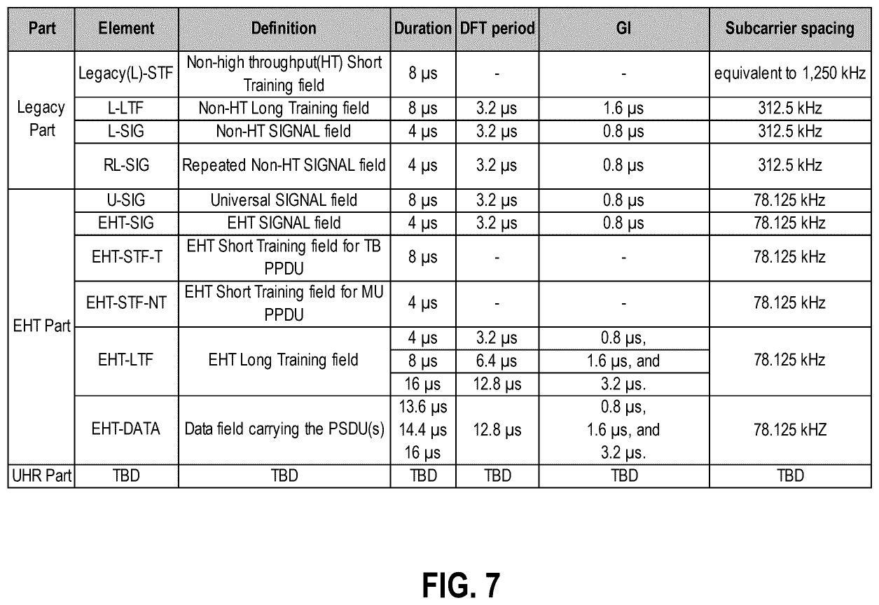

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

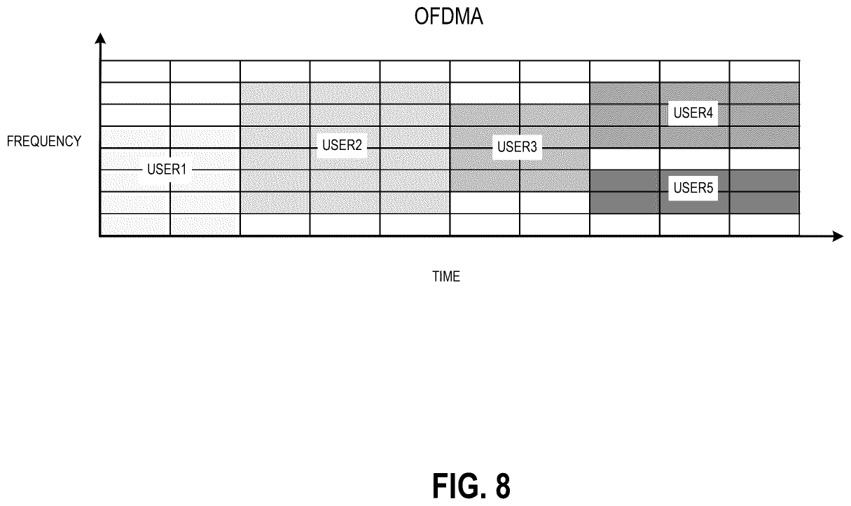

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

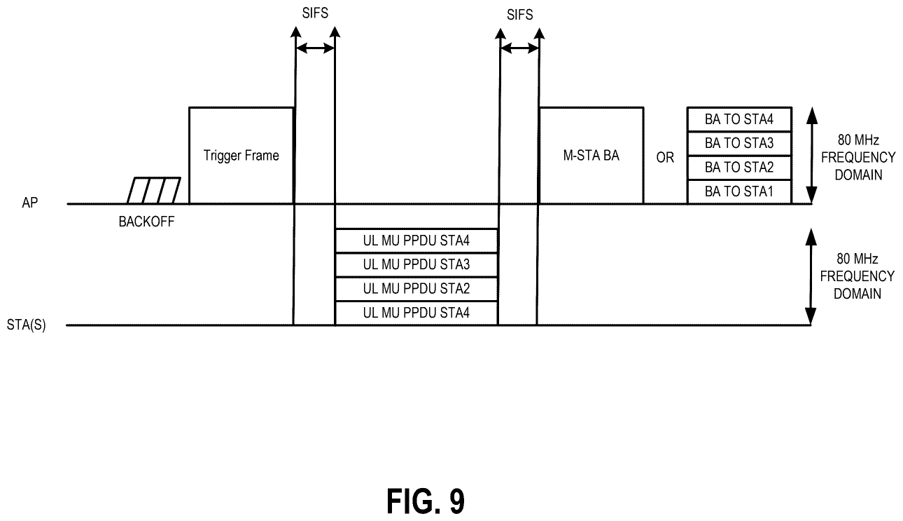

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Existing wireless networking standards (e.g., IEEE 802.11be wireless networking standard and Extremely High Throughput (EHT)) allow a STA to provide a BQR to an associated AP. The BQR may include subchannel availability information such as information regarding which 20 Megahertz (MHz) subchannels within an operating channel bandwidth are available at the STA. The information provided by the BQR may be referred to as BQR information. A STA may provide a BQR to an associated AP by transmitting a frame to the associated AP that includes a BQR field (e.g., within an aggregated control (A-control) field included in the frame). The BQR field may carry a bitmap indicating which 20 MHz subchannels within the operating channel bandwidth are available at the STA. The associated AP may determine which subchannels are available at the STA based on the bitmap included in the BQR field. Multiple STAs associated with the AP may each provide a BQR to the AP to inform the AP of the subchannels available at the respective STAs. The AP's knowledge of which subchannels are available at different STAs may assist the AP in allocating downlink (DL) and/or uplink (UL) multi-user (MU) resources, which enables more efficient MU operations.

For future wireless networking standards (e.g., beyond IEEE 802.11be wireless networking standard or Ultra High Reliability (UHR)), multi-AP coordination schemes are being considered as a way to enhance network performance. In a multi-AP coordination scenario, it may be useful for an AP to have information regarding which subchannels are available at a STA with respect to the BSS operated by the AP and also to have information regarding which subchannels are available at the STA with respect to any OBSSs operated by other APs. That is, it may be useful for the AP to have BQR information for its own BSS and any OBSSs. However, the current BQR format only allows a STA to provide BQR information for the STA's associated BSS to the AP. Thus, there is a need for a STA to be able to provide BQR information for more than one BSS, including OBSSs.

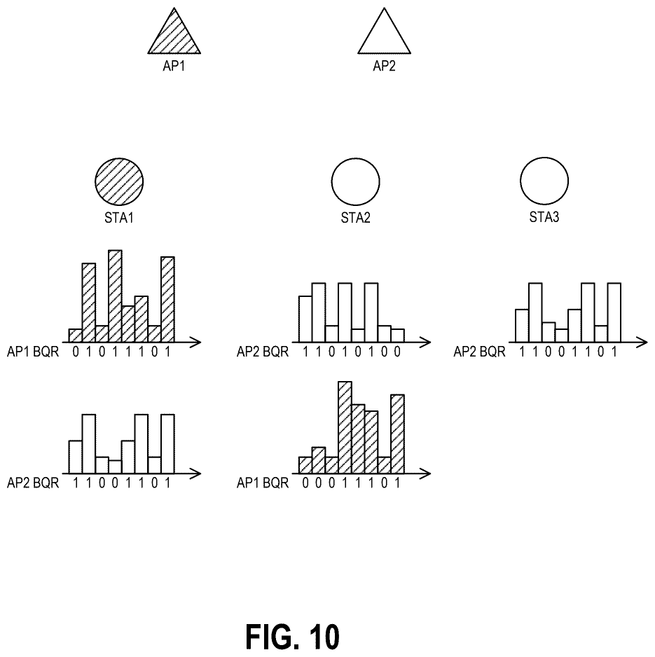

FIG. 10 is a diagram showing an example of BQR information gathered by various STAs in a wireless network in a multi-AP coordination scenario, according to some embodiments.

As shown in the diagram, the wireless network includes a first AP (AP1), a second AP (AP2), a first STA (STA1), a second STA (STA2), and a third STA (STA3). AP1 may operate a first BSS and AP2 may operate a second BSS. AP1 and AP2 may coordinate with each other using one or more multi-AP coordination schemes (e.g., coordinated time division multiple access (CTDMA), coordinated orthogonal frequency division multiple access (COFDMA), joint transmission (JT), coordinated beamforming (CBF), co-UL-MU-MIMO, coordinated spatial reuse (CSR), and so on). In this example, STA1 is associated with AP1. Thus, STA1 belong to the first BSS. Also, in this example, STA2 and STA3 are associated with AP2. Thus, STA2 and STA3 belong to the second BSS. Thus, from the perspective of STA1, the first BSS is an associated BSS and the second BSS is an OBSS. Also, from the perspective of STA2, the second BSS is an associated BSS and the first BSS is an OBSS.

In this example, it is assumed that STA1 and STA2 are able to receive downlink signals from both AP1 and AP2. A STA may determine the source (the transmitting AP) and direction of a received downlink signal based on the BSS color bits and DL/UL bits included in a SIGNAL field. STA1 may generate BQR information for both the first BSS and the second BSS based on downlink signals received from AP1 and AP2, respectively, and store this BQR information. Similarly, STA2 may generate BQR information for both the first BSS and the second BSS based on downlink signals received from AP1 and AP2, respectively, and store this BQR information. In the example shown in the diagram, STA1 stores BQR information for the first BSS (AP1's BSS) indicating that subchannels 2, 4, 5, 6, and 8 are idle/available and also stores BQR information for the second BSS (AP2's BSS) indicating that subchannels 1, 2, 5, 6, and 8 are idle/available. Also, STA2 stores BQR information for the first BSS (AP1's BSS) indicating that subchannels 1, 2, 4, and 6 are idle/available and also stores BQR information for the second BSS (AP2's BSS) indicating that subchannels 4, 5, 6, and 8 are idle/available. Also, in this example, it is assumed that STA3 only receives downlink signals from AP2. STA3 may generate BQR information for the second BSS based on downlink signals received from AP2 and store this BQR information. In the diagram, the BQR information for a BSS is represented as a bar graph. Each bar in a bar graph may correspond to a particular subchannel within an operating channel bandwidth (e.g., the first bar corresponds to subchannel 1, the second bar corresponds to subchannel 2, and so on). The height of a bar may represent the channel quality/gain of the corresponding subchannel (a taller height indicates higher channel quality/gain and a lower height indicates lower channel quality/gain). A value of ‘0’ beneath a bar may indicate that the corresponding subchannel is considered as being busy/unavailable (e.g., the channel quality/gain is below a threshold level). A value of ‘1’ beneath a bar may indicate that the corresponding subchannel is considered as being idle/available (e.g., the channel quality/gain is above a threshold level).

In an embodiment, a STA may provide a CBQR to the AP. Unlike a conventional BQR that can only accommodate BQR information for the STA's associated BSS to the AP, the CBQR may include BQR information for the STA's associated BSS and/or BQR information for one or more OBSSs with respect to the STA. For example, STA1 may provide a CBQR to AP1 that includes BQR information for the first BSS (STA1's associated BSS) and BQR information for the second BSS (which is an OBSS with respect to STA1). STA1's BQR information for the first BSS may include information regarding subchannel availability at STA1 with respect to the first BSS. STA1's BQR information for the second BSS may include information regarding subchannel availability at STA1 with respect to the second BSS. Similarly, STA2 may provide a CBQR to AP2 that includes BQR information for the first BSS (which is an OBSS with respect to STA2) and BQR information for the second BSS (STA2's associated BSS). STA2's BQR information for the first BSS may include information regarding subchannel availability at STA2 with respect to the first BSS. STA2's BQR information for the second BSS may include information regarding subchannel availability at STA2 with respect to the second BSS. In an embodiment, subchannel availability information is conveyed in units of 20 MHz subchannels, but it should be appreciated that other subchannel sizes are possible.

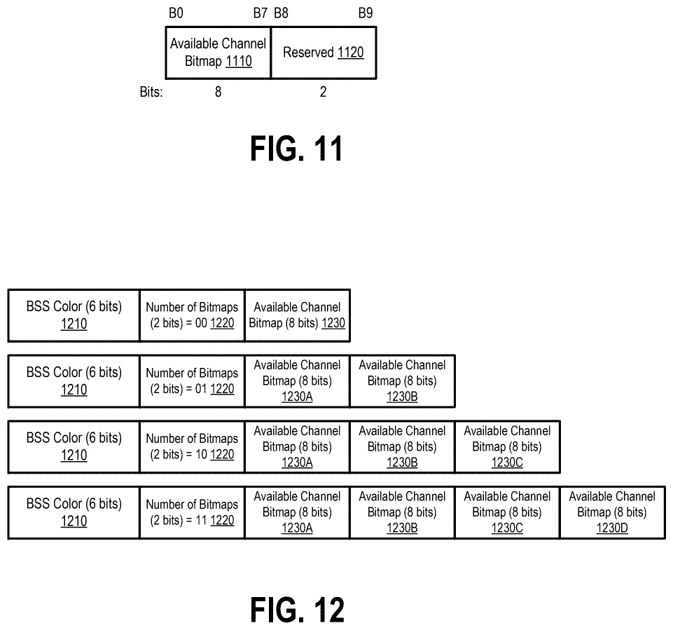

FIG. 11 is a diagram showing a format of a BQR field in EHT. As shown in the diagram, the BQR field includes an available channel bitmap field 1110 (8 bits) and a reserved field 1120 (2 bits). A STA may provide a BQR to an AP by transmitting the BQR field to the AP. The available channel bitmap field 1110 may carry a bitmap indicating subchannel availability at the STA with respect to the STA's associated BSS. Each bit in the bitmap may correspond to a 20 MHz subchannel within the operating channel bandwidth of the associated BSS, with the LSB (least significant bit) corresponding to the lowest numbered operating 20 MHz subchannel of the BSS. The bit in position X in the bitmap may be set to ‘1’ to indicate that subchannel X+1 is idle; otherwise, it may be set to ‘0’ to indicate that the subchannel is busy or unavailable.

The current BQR format only accommodate BQR information for the transmitting STA's associated BSS. As previously mentioned, in a multi-AP coordination scenario, it may be useful for an AP to have BQR information for more than one BSS. For example, it may be useful for an AP to have information regarding which subchannels are available at a STA with respect to its own BSS and any OBSSs. However, the current BQR format is limited to providing BQR information for the transmitting STA's associated BSS and cannot accommodate BQR information for more than one BSS.

To address this deficit, a new type of report, referred to herein as a CBQR, is introduced herein. A STA may provide a CBQR to an AP that includes BQR information for one or more BSSs. A STA may transmit the CBQR by transmitting one or more CBQR fields to the AP. Each CBQR field may include a BSS color field that carries a BSS color of a particular BSS and an available channel bitmap field that carries a bitmap indicating subchannel availability at the STA with respect to the particular BSS. The particular BSS may be the STA's associated BSS or an OBSS with respect to the STA. In an embodiment, CBQR fields are included in an A-control field included in a frame. The frame may be a control frame, a management frame, or a data frame. Multiple CBQR fields can be included in a frame to provide BQR information for multiple BSSs. It is noted that the number of bits included in the existing A-control field can be extended to accommodate one or more CBQR fields. In an embodiment, a CBQR field is allowed to include more than one available channel bitmap field to carry information regarding subchannel availability at a STA for a wider bandwidth.

In an embodiment, an AP may indicate to a STA that it supports CBQR. For example, one of the bits in the MAC capability information field may be designated for indicating support for CBQR (such bit may be referred to herein as a CBQR support bit). The AP may transmit the MAC capability information field to the STA with the CBQR support bit set (e.g., to a value of ‘1’) to indicate that it supports CBQR. If the AP supports CBQR, the STA may provide CBQRs to the AP in accordance with embodiments described herein.

An example format of a CBQR field is shown in FIG. 12 and described in further detail below.

FIG. 12 is a diagram showing a format of a CBQR field, according to some embodiments.

As shown in the diagram, the CBQR field includes a BSS color field 1210 (6 bits), a number of bitmaps field 1220 (2 bits), and one or more available channel bitmap fields 1230 (8 bits each). While a particular format of a CBQR field is shown in the diagram and described herein, it should be appreciated that the format of a CBQR field can differ from what is shown in the diagram and described herein. For example, the fields included in the CBQR field may have different widths/sizes and/or be arranged in a different order. Also, it should be appreciated that the CBQR field may include additional fields not shown in the diagram.

The BSS color field 1210 may be used for carrying a BSS color of a BSS. The BSS color may be the BSS color included in the SIGNAL field included in a downlink frame received from the AP that operates the BSS. The BSS color of an AP may be the AP's address, a truncated version of the AP's address, the AP's AID (association identifier), or other type of identifier.

The number of bitmaps field 1220 may be used for carrying an indication of the number of available channel bitmap fields 1230 included in the CBQR field. For example, the number of bitmaps field 1220 may carry a value of binary ‘00’ to indicate that the CBQR field includes one available subchannel bitmap field 1230, carry a value of binary ‘01’ to indicate that the CBQR field includes two available subchannel bitmap fields 1230, carry a value of binary ‘10’ to indicate that the CBQR field includes three available subchannel bitmap fields 1230, and carry a value of binary ‘11’ to indicate that the CBQR field includes four available subchannel bitmap fields 1230. While a particular convention for indicating the number of available subchannel bitmap fields is described, it should be appreciated that the use of other conventions is possible.

Each available channel bitmap field 1230 may be used for carrying a bitmap indicating subchannel availability at a STA with respect to the BSS corresponding to the BSS color carried by the BSS color field 1210. In an embodiment, each bitmap includes eight bits. Each bit in the bitmap may correspond to a 20 MHz subchannel within the operating channel bandwidth of the BSS, with the LSB (least significant bit) corresponding to the lowest numbered operating 20 MHz subchannel of the BSS. The bit in position X in the bitmap may be set to ‘1’ to indicate that subchannel X+1 is idle; otherwise, it may be set to ‘0’ to indicate that the subchannel is busy or unavailable. It should be appreciated, however, that a different format/convention can be used for indicating subchannel availability. For example, the bitmap may include more than eight bits or less than eight bits. Also, the subchannel size can be larger than 20 MHz or smaller than 20 MHz.

The diagram shows the formats of a CBQR field for the case when the number of available channel bitmaps fields included in the CBQR field is one, two, three, and four respectively. As shown in the diagram, when the number of bitmaps field 1220 carries a value of ‘00’, the CBQR field may include a single available channel bitmap field 1230. When the number of bitmaps field 1220 carries a value of ‘01’, the CBQR field may include two available channel bitmap fields (available channel bitmap field 1230A and available channel bitmap field 1230B). When the number of bitmaps field 1220 carries a value of ‘10’, the CBQR field may include three available channel bitmap fields (available channel bitmap field 1230A, available channel bitmap field 1230B, and available channel bitmap field 1230C). When the number of bitmaps field 1220 carries a value of ‘11’, the CBQR field may include four available channel bitmap fields (available channel bitmap field 1230A, available channel bitmap field 1230B, available channel bitmap field 1230C, and available channel bitmap field 1230D).

A STA may transmit multiple CBQR fields (e.g., in an A-control field) to the AP to provide BQR information for multiple different BSSs. Also, a STA may transmit multiple available channel bitmap fields 1230 for a given BSS to provide subchannel availability information for a wider bandwidth (e.g., to support multi-link operations (MLO)). In EHT, a STA may transmit two BQR fields to provide subchannel availability information for a primary 160 MHz bandwidth and a secondary 160 MHz bandwidth, respectively. Thus, the maximum bandwidth size supported by the EHT BQR is 320 MHz. Advantageously, the CBQR described herein may support a 640 MHz bandwidth (e.g., assuming that a CBQR field can carry up to four eight-bit bitmaps and the subchannel size is 20 MHz). As such, in a multi-link operation (MLO) scenario, a single CBQR field can provide subchannel availability information for multiple links.

In an embodiment, CBQR fields are used for carrying BQR information for both the transmitting STA's associated BSS and OBSSs. For example, a STA may transmit a first CBQR field that carries BQR information for the STA's associated BSS and transmit a second CBQR field that carries BQR information for an OBSS with respect to the STA (e.g., in the same A-control field). In an alternative embodiment, the conventional BQR field (e.g., the one specified in EHT) is used for carrying BQR information for the transmitting STA's associated BSS and CBQR fields are used for carrying BQR information for OBSSs. That is, CBQR fields may be used exclusively for carrying BQR information for OBSSs and not used for carrying BQR information for the transmitting STA's associated BSS. For example, a STA may transmit a conventional BQR field that carries BQR information for the STA's associated BSS and transmit a CBQR field that carries BQR information for an OBSS (e.g., in the same A-control field).

In an embodiment, if the operating channel bandwidth of a STA's associated BSS and the operating channel bandwidth of an OBSS with respect to the STA at least partially overlap, the STA may generate the BQR information for the STA's associated BSS based on BQR information for the OBSS with respect to the STA. For example, for a subchannel that is within an overlapping portion of the operating channel bandwidths of the STA's associated BSS and the OBSS, the STA may set the bit corresponding to the subchannel in the bitmap included in the CBQR field for the STA's associated BSS to indicate that the subchannel is busy/unavailable (e.g., set the bit to ‘0’) if the subchannel is unavailable at the STA with respect to the OBSS even though the subchannel is available at the STA with respect to the STA's associated BSS. The STA may set the bit corresponding to the subchannel in the bitmap to indicate that the subchannel is idle/available (e.g., set the bit to ‘1’) if the subchannel is available at the STA with respect to both the STA's associated BSS and the OBSS.

In an embodiment, two bits of the reserved field 1120 included in the conventional BQR field (e.g., bits B8 and B9 shown in FIG. 11) are used to indicate BSS color. For example, the two bits of the reserved field 1120 may be set to binary ‘00’ to indicate that the bitmap included in the available channel bitmap field 1110 applies to the transmitting STA's associated BSS. The other binary values (‘01’, ‘10’, and ‘11’) may be used for indicating OBSSs. The mapping between the other binary values and the OBSSs can be shared during an association process or via a control frame. In such an embodiment, BQR information for up to three OBSSs can be provided. However, this requires that the STA and the AP know the mapping between the binary values and the BSSs beforehand.

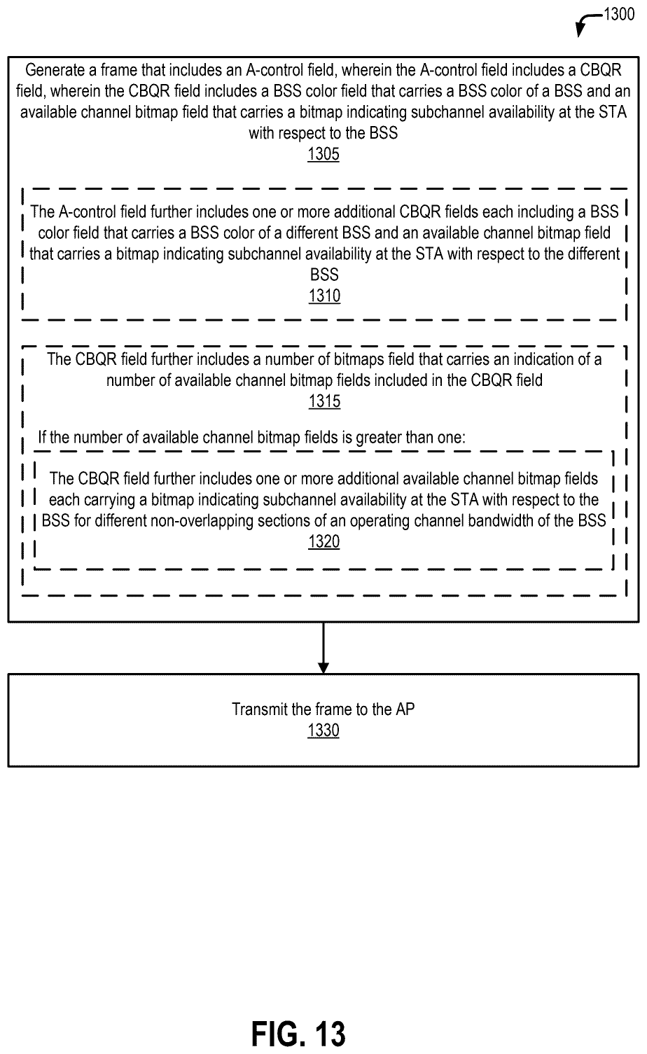

Turning now to FIG. 13, a method 1300 will be described for providing a CBQR to an AP, in accordance with an example embodiment. The method 1300 may be performed by a STA. The STA may be implemented by a wireless device (e.g., wireless device 104).

Additionally, although shown in a particular order, in some embodiments the operations of the method 1300 may be performed in a different order. For example, although the operations of the method 1300 are shown in a sequential order, some of the operations may be performed in partially or entirely overlapping time periods.

At operation 1305, the STA generates a frame that includes an A-control field, wherein the A-control field includes a CBQR field, wherein the CBQR field includes a BSS color field that carries a BSS color of a BSS and an available channel bitmap field that carries a bitmap indicating subchannel availability at the STA with respect to the BSS. The frame may be a control frame, management frame, or a data frame.

In an embodiment, as shown in block 1310, the A-control field further includes one or more additional CBQR fields each including a BSS color field that carries a BSS color of a different BSS and an available channel bitmap field that carries a bitmap indicating subchannel availability at the STA with respect to the different BSS. In an embodiment, the BSS is an associated BSS with respect to the STA and the different BSS is an OBSS with respect to the STA. In an embodiment, an operating channel bandwidth of the BSS and an operating channel bandwidth of the different BSS at least partially overlap, wherein a subchannel within an overlapping portion of the operating channel bandwidths of the BSS and the different BSS is indicated in the bitmap (that applies to the BSS) as being unavailable due to the subchannel being unavailable at the STA with respect to the different BSS even though the subchannel is available at the STA with respect to the BSS. In an embodiment, the AP determines a subchannel to allocate to the STA for a MU transmission based on the bitmap indicating subchannel availability at the STA with respect to the BSS and the bitmap indicating subchannel availability at the STA with respect to the different BSS.

In an embodiment, the BSS is an OBSS with respect to the STA, wherein the A-control field further includes a BQR field that includes an available channel bitmap field that carries a bitmap indicating subchannel availability at the STA with respect to an associated BSS with respect to the STA. The BQR field may be a conventional BQR field that does not include a BSS color field.

In an embodiment, the BSS color field has a size of six bits.

In an embodiment, as shown in block 1315, the CBQR field further includes a number of bitmaps field that carries an indication of a number of available channel bitmap fields included in the CBQR field. In an embodiment, as shown in block 1320, if the number of available channel bitmap fields is greater than one, the CBQR field further includes one or more additional available channel bitmap fields each carrying a bitmap indicating subchannel availability at the STA with respect to the BSS for different non-overlapping sections of an operating channel bandwidth of the BSS. In an embodiment, the number of bitmaps field includes two bits. In such an embodiment, the two bits being set to ‘00’ may indicate that the CBQR field includes one available channel bitmap field, the two bits being set to ‘01’ may indicate that the CBQR field includes two available channel bitmap fields, the two bits being set to ‘10’ may indicate that the CBQR field includes three available channel bitmap fields, and the two bits being set to ‘11’ may indicate that the CBQR field includes four available channel bitmap fields. In an embodiment (e.g., where the number of bitmaps field indicates that the CBQR field includes four available channel bitmap fields), the CBQR field further includes a second available channel bitmap field that carries a second bitmap indicating subchannel availability at the STA with respect to the BSS, a third available channel bitmap field that carries a third bitmap indicating subchannel availability at the STA with respect to the BSS, and a fourth available channel bitmap field that carries a fourth bitmap indicating subchannel availability at the STA with respect to the BSS, wherein the bitmap, the second bitmap, the third bitmap, and the fourth bitmap each cover different non-overlapping sections of an operating channel bandwidth of the BSS. In an embodiment, the bitmap includes eight bits with each bit corresponding to a different 20 MHz subchannel within a first 160 MHz section of the operating channel bandwidth of the BSS covered by the bitmap, wherein the second bitmap includes eight bits with each bit corresponding to a different 20 MHz subchannel withing a second 160 MHz section of the operating channel bandwidth of the BSS covered by the second bitmap, wherein the third bitmap includes eight bits with each bit corresponding to a different 20 MHz subchannel withing a third 160 MHz section of the operating channel bandwidth of the BSS covered by the third bitmap, wherein the fourth bitmap includes eight bits with each bit corresponding to a different 20 MHz subchannel withing a fourth 160 MHz section of the operating channel bandwidth of the BSS covered by the second bitmap.

At operation 1330, the STA transmits the frame to the AP. In an embodiment, before transmitting the frame to the AP, the STA determines/confirms that the AP supports CBQR based on a value of a CBQR support bit included in a MAC capability information field included in a management frame received from the AP.

In an embodiment, the AP uses the information provided by the CBQR field(s) to determine the appropriate coordination scheme, operating bandwidth, and/or subchannel allocation to use for multi-AP coordination operations.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a station (STA) to provide a coordinated bandwidth query report (CBQR) to an access point (AP), the method comprising:
generating a frame that includes an aggregated control (A-control) field, wherein the A-control field includes a CBQR field, wherein the CBQR field includes a basic service set (BSS) color field that carries a BSS color of a BSS and an available channel bitmap field that carries a bitmap indicating subchannel availability at the STA with respect to the BSS; and
transmitting the frame to the AP.

2. The method of claim 1, wherein the A-control field further includes a second CBQR field, wherein the second CBQR field includes a second BSS color field that carries a second BSS color of a second BSS and a second available channel bitmap field that carries a second bitmap indicating subchannel availability at the STA with respect to the second BSS.

3. The method of claim 2, wherein the BSS is an associated BSS with respect to the STA and the second BSS is an overlapping BSS (OBSS) with respect to the STA.

4. The method of claim 2, wherein an operating channel bandwidth of the BSS and an operating channel bandwidth of the second BSS at least partially overlap, wherein a subchannel within an overlapping portion of the operating channel bandwidths of the BSS and the second BSS is indicated in the bitmap as being unavailable due to the subchannel being unavailable at the STA with respect to the second BSS even though the subchannel is available at the STA with respect to the BSS.

5. The method of claim 2, wherein the AP determines a subchannel to allocate to the STA for a multi-user (MU) transmission based on the bitmap and the second bitmap.

6. The method of claim 1, wherein the BSS is an overlapping BSS with respect to the STA, wherein the A-control field further includes a bandwidth query report (BQR) field that includes an available channel bitmap field that carries a bitmap indicating subchannel availability at the STA with respect to an associated BSS with respect to the STA.

7. The method of claim 1, wherein the BSS color field has a size of six bits.

8. The method of claim 1, wherein the CBQR field further includes a number of bitmaps field that carries an indication of a number of available channel bitmap fields included in the CBQR field.

9. The method of claim 8, wherein the number of bitmaps field includes two bits, wherein the two bits being set to “00” indicates that the CBQR field includes one available channel bitmap field, wherein the two bits being set to “01” indicates that the CBQR field includes two available channel bitmap fields, wherein the two bits being set to “10” indicates that the CBQR field includes three available channel bitmap fields, and wherein the two bits being set to “11” indicates that the CBQR field includes four available channel bitmap fields.

10. The method of claim 8, wherein the CBQR field further includes a second available channel bitmap field that carries a second bitmap indicating subchannel availability at the STA with respect to the BSS, a third available channel bitmap field that carries a third bitmap indicating subchannel availability at the STA with respect to the BSS, and a fourth available channel bitmap field that carries a fourth bitmap indicating subchannel availability at the STA with respect to the BSS, wherein the bitmap, the second bitmap, the third bitmap, and the fourth bitmap each cover different non-overlapping sections of an operating channel bandwidth of the BSS.

11. The method of claim 10, wherein the bitmap includes eight bits with each bit corresponding to a different 20 Megahertz (MHz) subchannel within a first 160 MHz section of the operating channel bandwidth of the BSS covered by the bitmap, wherein the second bitmap includes eight bits with each bit corresponding to a different 20 MHz subchannel withing a second 160 MHz section of the operating channel bandwidth of the BSS covered by the second bitmap, wherein the third bitmap includes eight bits with each bit corresponding to a different 20 MHz subchannel withing a third 160 MHz section of the operating channel bandwidth of the BSS covered by the third bitmap, wherein the fourth bitmap includes eight bits with each bit corresponding to a different 20 MHz subchannel withing a fourth 160 MHz section of the operating channel bandwidth of the BSS covered by the second bitmap.

12. The method of claim 1, further comprising:
determining that the AP supports CBQR based on a value of a CBQR support bit included in a media access control (MAC) capability information field included in a management frame received from the AP.

13. A wireless device to implement a station (STA) to provide a coordinated bandwidth query report (CBQR) to an access point (AP), the wireless device comprising:
a radio frequency transceiver;
a memory device storing a set of instructions; and
a processor coupled to the memory device, wherein the set of instructions, when executed by the processor, causes the STA to:
generate a frame that includes an aggregated control (A-control) field, wherein the A-control field includes a CBQR field, wherein the CBQR field includes a basic service set (BSS) color field that carries a BSS color of a BSS and an available channel bitmap field that carries a bitmap indicating subchannel availability at the STA with respect to the BSS; and
transmit the frame to the AP.

14. The wireless device of claim 13, wherein the A-control field further includes a second CBQR field, wherein the second CBQR field includes a second BSS color field that carries a second BSS color of a second BSS and a second available channel bitmap field that carries a second bitmap indicating subchannel availability at the STA with respect to the second BSS.

15. The wireless device of claim 14, wherein the BSS is an associated BSS with respect to the STA and the second BSS is an overlapping BSS (OBSS) with respect to the STA.

16. The wireless device of claim 14, wherein an operating channel bandwidth of the BSS and an operating channel bandwidth of the second BSS at least partially overlap, wherein a subchannel within an overlapping portion of the operating channel bandwidths of the BSS and the second BSS is indicated in the bitmap as being unavailable due to the subchannel being unavailable at the STA with respect to the second BSS even though the subchannel is available at the STA with respect to the BSS.

17. The wireless device of claim 14, wherein the AP determines a subchannel to allocate to the STA for a multi-user (MU) transmission based on the bitmap and the second bitmap.

18. The wireless device of claim 13, wherein the BSS is an overlapping BSS with respect to the STA, wherein the A-control field further includes a bandwidth query report (BQR) field that includes an available channel bitmap field that carries a bitmap indicating subchannel availability at the STA with respect to an associated BSS with respect to the STA.

19. The wireless device of claim 13, wherein the CBQR field further includes a number of bitmaps field that carries an indication of a number of available channel bitmap fields included in the CBQR field.

20. The wireless device of claim 19, wherein the number of bitmaps field includes two bits, wherein the two bits being set to “00” indicates that the CBQR field includes one available channel bitmap field, wherein the two bits being set to “01” indicates that the CBQR field includes two available channel bitmap fields, wherein the two bits being set to “10” indicates that the CBQR field includes three available channel bitmap fields, and wherein the two bits being set to “11” indicates that the CBQR field includes four available channel bitmap fields.
